(19) United States
(12) Patent Application Publication
(10) Pub. No.: US 2026/0062145 A1
(43) Pub. Date: Mar. 5, 2026

(54) ELECTRICAL ENERGY RECEPTION SYSTEM FOR MOVING AN AIRCRAFT DURING TAXIING

(71) Applicant: Airbus SAS, BLAGNAC (FR)

(72) Inventors: Francois ROUYRE, BLAGNAC (FR); Didier CHASSAIGNE, BLAGNAC (FR); Olivier CREPEL, BLAGNAC (FR)

(21) Appl. No.: 19/299,906

(22) Filed: Aug. 14, 2025

(30) Foreign Application Priority Data
Aug. 30, 2024 (FR) FR2409255

(51) Int. Cl. B64F 1/35; H02J 50/10

(52) U.S. Cl. CPC B64F 1/35; H02J 50/10

(57) ABSTRACT

An electrical energy reception system for an aircraft, having an electrical energy reception device, the electrical energy reception device has an electrical energy reception element, called a receiver, configured to receive electrical energy emitted by an electrical energy transmitter, the electrical energy reception device being mounted with the ability to move between a retracted position and a deployed position, the electrical energy reception system also has a compartment for housing the electrical energy reception device in the retracted position.

### CROSS-REFERENCES TO RELATED APPLICATIONS

This application claims the benefit of French Patent Application Number FR2409255 filed on Aug. 30, 2024, the entire disclosure of which is incorporated herein by way of reference.

### FIELD OF THE INVENTION

The present invention relates to an electrical energy reception system for moving an aircraft during taxiing.

### BACKGROUND OF THE INVENTION

Before taking off or after landing, an aircraft moves along the ground by taxiing along a taxiway of an airport facility between the area in which it is parked and the runway used for taking off and landing. During this so-called taxiing phase, the aircraft is rolling. During this phase, the aircraft uses the thrust generated by its propulsion units. The use of an electric traction motor powered by its auxiliary power unit (APU) is also possible, but is still at the feasibility study stage.

These solutions are not optimal because the aircraft consumes energy in the form of fuel stored in its fuel tanks in order to move along the ground, which means that the fuel consumption and the all-up weight of the aircraft increase.

The aim of the invention is to at least partially overcome these drawbacks.

### SUMMARY OF THE INVENTION

To this end, what is proposed is an electrical energy reception system for an aircraft, comprising an electrical energy reception device, the electrical energy reception device comprising an electrical energy reception element, called a receiver, configured to receive electrical energy emitted by an electrical energy emitting element, called a transmitter, the electrical energy reception device being mounted with the ability to move between a retracted position and a deployed position, the electrical energy reception system comprising a compartment for housing said electrical energy reception device in the retracted position.

By virtue of the system according to the present invention, it is possible to electrically power an electric motor for the landing gears of the aircraft, thereby making it possible to avoid having to use the aircraft propulsion unit(s) for taxiing, and thus making it possible to reduce the all-up weight and the fuel consumption of the aircraft. The latter therefore no longer consumes fuel when taxiing.

It should be noted that the transmitter is distinct from the system of which it does not form part.

According to another aspect, the electrical energy reception device comprises a holding structure for the receiver and at least one actuator for driving the structure between the position in which the system is retracted and the position in which same is deployed.

According to another aspect, the compartment comprises a fairing equipped with at least one mobile wall able to move between the position in which the compartment is closed and the position in which the compartment is fully open.

According to another aspect, said at least one mobile wall is secured to the structure so that the actuator drives said at least one mobile wall between the closed position and the fully-open position.

According to another aspect, the system comprises an actuator for pivoting the receiver.

According to another aspect, the system comprises a carriage carrying the receiver.

According to another aspect, the receiver comprises an induction pad for collaborating with the transmitter in a contactless manner and/or a contact for collaborating with the transmitter by contact.

According to another aspect, the system comprises an electric motor configured to operate at least one wheel of a landing gear of the aircraft and configured to be electrically powered via the receiver.

Another subject of the invention is an aircraft comprising a system as described hereinabove.

According to another aspect, the compartment is attached to the fuselage of the aircraft, preferably in the vicinity of a landing gear.

Another subject of the invention is an electrical energy transfer system comprising an aircraft as described hereinabove, and an electrical energy transmitter configured to electrically power the receiver when the electrical energy reception system is in the deployed position.

### BRIEF DESCRIPTION OF THE DRAWINGS

Other features, details and advantages will appear from reading the detailed description below, and from analyzing the attached drawings, in which:

FIG. 1 is a schematic perspective view, from the side, of a forward part of an aircraft equipped with an electrical energy reception system according to one embodiment of the present invention, in a retracted position.

FIG. 2 is a schematic perspective view, from the side, of the forward part of FIG. 1, with the electrical energy reception system in a deployed position.

FIG. 3 is a schematic perspective view, from the side, of the electrical energy reception system of FIG. 1.

FIG. 4 is a schematic perspective view, from the side, of the electrical energy reception system of FIG. 2.

FIG. 5 is a schematic rear view of the system of FIG. 1.

FIG. 6 is a schematic rear view of the system of FIG. 2.

FIG. 7 is a schematic rear view of the electrical energy reception system of FIG. 1 according to a variant embodiment of the invention.

FIG. 8 is a schematic view of a detail of the electrical energy reception system of FIG. 7.

### DETAILED DESCRIPTION OF THE PREFERRED EMBODIMENTS

The examples and the related conditions detailed here are mainly intended to help the reader understand the principles of the present invention and not to limit its scope to these specific examples and conditions. It will be understood that a person skilled in the art can conceive of various arrangements which, although not explicitly described or represented here, nevertheless embody the principles of the present invention and are included in its spirit and scope.

Furthermore, to facilitate understanding, the following description may describe relatively simplified implementations of the present invention. As a person skilled in the art will understand, other implementations of the present invention may be of greater complexity.

In some cases, examples of modifications of the present invention may also be presented. This is done simply as an aid to understanding, and, once again, not for the purposes of defining the scope or establishing the limits of the present invention. These modifications are not an exhaustive list, and a person skilled in the art may make other modifications while still remaining within the scope of the present invention.

Furthermore, all the statements below relating to the principles, aspects and implementations of the present invention, as well as the specific examples thereof, aim to encompass both the structural and functional equivalents thereof, whether they are currently known or developed in the future.

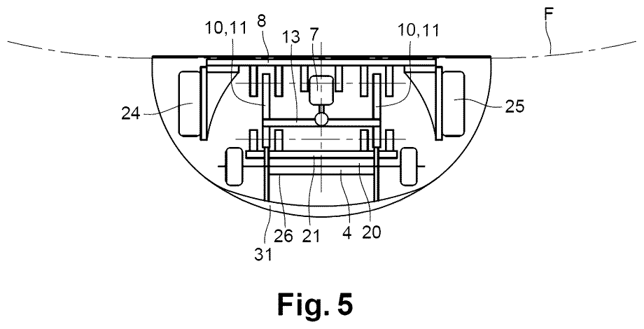

As is evident from FIGS. 1 to 8, the subject of the invention is an electrical energy reception system, referenced 1 in the figures. The system 1 comprises an electrical energy reception device, referenced 2 (which may be seen as being the uplift actuating cylinder of the system 1), and a compartment 3 for housing the electrical energy reception device 2. The system 1 is intended to equip an aircraft A, and another subject of the invention is the aircraft A equipped with the system 1.

The electrical energy reception device 2 comprises an electrical energy reception element, called a receiver, referenced 4. The receiver 4 is configured to receive electrical energy emitted by a transmitter 5 distinct from the electrical energy reception system 1, as will be detailed later.

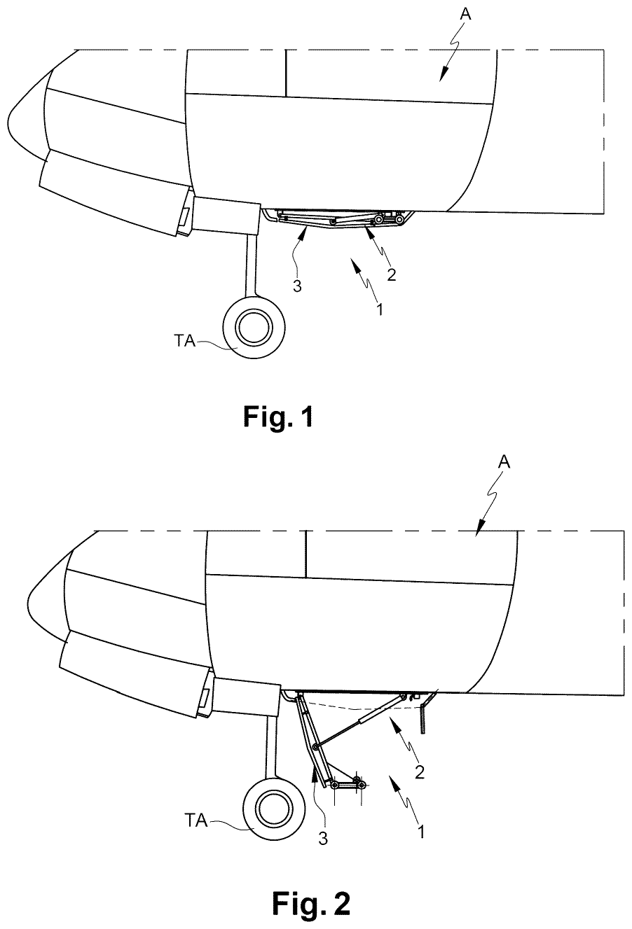

As is visible in the figures, the device 2 is mounted with the ability to move between a retracted position, illustrated in FIGS. 1, 3, 5 and 7, in which the receiver 4 is positioned inside the compartment 3, and a deployed position, illustrated in FIGS. 2, 4, 6 and 8, in which the receiver 4 is positioned outside of the compartment 3 and at a distance sufficient for receiving the energy emitted by the emitting element, e.g., transmitter 5.

As is also evident from the figures, the compartment 3 is mounted with the ability to move between a closed position and a position referred to as fully open.

The system 1 is configured so that when the compartment 3 is in the closed position, the device 2 is in the retracted position, and when the compartment 3 is in the fully-open position, the device 2 may be deployed, as will be described later.

The device 2 is now described.

The device 2 comprises a support 6 for the receiver 4, mounted with the ability to move, and an actuator 7 that drives the movement of the support 6. The device 2 also comprises a structural element 8 configured to be attached to the fuselage of the aircraft A and secured to the support 6 and to the actuator 7.

The support 6 advantageously comprises two parallel arms 10, 11, and at least one connecting arm which connects the parallel arms 10, 11 to one another. Each connecting arm is preferably positioned orthogonally with respect to the parallel arms 10, 11. In the embodiment illustrated, the support 6 comprises three connecting arms 12, 13, 14, referred to respectively as the upper, lower and intermediate arm.

Each of the arms 10, 11 extends between a first end 15 secured to the structural element 8 via a pivot connection P and a second end 16 secured to the receiver 4 via a pivot connection P.

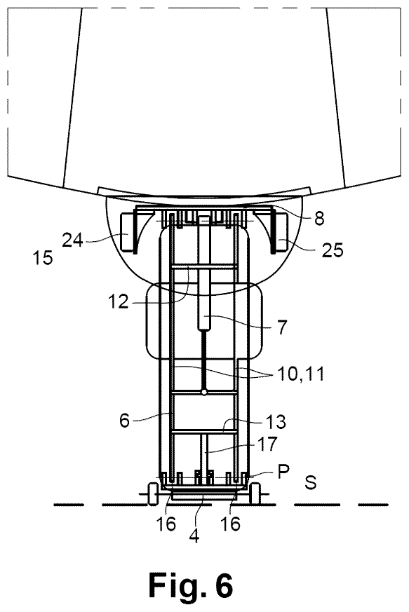

As is best visible in FIG. 6, the upper connecting arm 12 is positioned in the upper part of the system 1 when the system 1 is in the deployed position, for example in the upper ⅕^{th} part. In other words, the upper connecting arm 12 is positioned as close as possible to the upper end 15 so as to stiffen same, and for example is positioned at a level lying in the upper portion and corresponding height wise to the upper one fifth of the height of the arms 10, 11.

The lower connecting arm 13 is positioned in the lower part of the system 1 when the system 1 is in the deployed position, for example in the lower ⅕^{th} part. In other words, the lower connecting arm 13 is positioned as close as possible to the lower end 16 so as to stiffen same, and for example is positioned at a level lying in the lower portion and corresponding height wise to the lower one fifth of the height of the arms 10, 11.

The arm 13 is secured, preferably at its middle, to an actuator 17 for deploying the receiver 4, as will be described later on.

The intermediate connecting arm 14 is positioned between the upper connecting arm 12 and the lower connecting arm 13, for example in the lower ⅓. The arm 14 is secured, preferably at its middle, to the actuator 7.

The invention is not restricted to this configuration, and any type of structure able to act as a support for the receiver 4 may be envisioned. In particular, the device 2 may comprise just one arm 10, or more than two arms 10, 11; likewise it may comprise no connecting arm, or one or two connecting arms, or else more than three connecting arms. The connecting arms may be uniformly or non-uniformly spaced, notably according to the shape and dimensions of the compartment 3, of the device 2.

In the embodiment illustrated, the actuator 7 is an actuating cylinder, for example a hydraulic or pneumatic cylinder, of which a cylinder body 18 is secured to the structural element 8 of the system 1 and a rigid rod 19 is secured by one end to the intermediate connecting arm 14. The rod 19 slides, via an internal piston, in the cylinder body 18 between a rest position in which the rod is inside the cylinder body 18 and an extended position in which the rod 19 protrudes from the cylinder body 18. When the actuating cylinder is in the rest position, the system 1 is in the retracted position. When the rod 19 slides between the rest position and the extended position, the support 6 is pushed by the rod 19, and this causes the parallel arms 10, 11 to pivot about their respective axle of the pivot connections 15, from the position in which the system 1 is retracted to the position in which the system 1 is deployed.

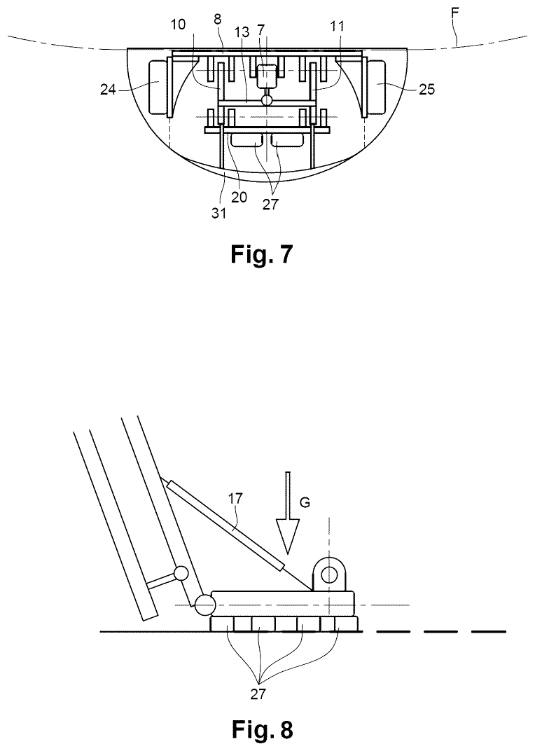

As may be seen in the figures, the system 1 comprises a carriage 20 carrying the receiver 4. The carriage 20 comprises a platform 21 on which the axles of the pivot connections 16 of the parallel arms 10, 11 are mounted. The carriage 20 is either equipped with wheels, as in a first preferred variant embodiment, illustrated in FIGS. 1 to 6, or not equipped with wheels, as in a second variant embodiment illustrated in FIGS. 7 and 8.

The carriage 20 is advantageously equipped with an axle 22 around which a hook 23 of the structural element 8 is hooked. The axle 22 and the hook 23 form a locking means for locking the device 2 in the retracted position.

The system 1 also comprises an electric motor 24 and a unit 25 for distributing the electrical energy received by the receiver 4. The system also comprises an electrical cable C, or electrical wiring harness, which connects to the aircraft for transferring electrical energy. The electrical energy received by the receiver 4 may be transferred to the electric motor 24, potentially via the unit 25, to operate the wheels of the landing gear. The invention is not restricted to this configuration and the electrical energy received by the system 1 may be transferred to an electric motor positioned outside of the system 1, for example positioned at the wheels of the landing gears.

The receiver 4 is mounted under the platform 21.

In the first variant, the receiver 4 takes the form of a pad 26, whereas in the second variant, the receiver 4 takes the form of a set of contacts 27.

The pad 26 is configured to transfer, in a contactless manner, the electrical energy emitted by the transmitter 5. For example, using inductive technology, the transmitter 5, preferably present on the ground S, is configured to generate an electromagnetic field, and the receiver 4 is an electromagnetic induction element configured to generate an electric current when positioned in the magnetic field generated by the transmitter 5. In that case, the receiver 4 comprises at least one coil.

Each contact 27 is configured to transfer the electrical energy emitted by the transmitter 5 when the contact 27 is in contact with the transmitter 5 which may, for example, take the form of rails on the ground S. In this variant, the actuator 17, for example a pneumatic or hydraulic actuating cylinder, applies enough force for electrical energy to be able to be transferred through friction.

The compartment 3 is now described.

As may be seen in the figures, the compartment 3 comprises a fairing 31 equipped with at least one mobile wall able to move between a closed position and a position referred to as the fully-open position. The fairing 31 is intended to be attached to part of the fuselage F of the aircraft A, in the vicinity of a landing gear, for example of the front landing gear TA, as illustrated in FIGS. 1 and 2.

An internal volume delimited by the fairing 31 when said at least one mobile wall is closed, and by that part of the fuselage F that lies inside the perimeter of the fairing 31, is denoted V. The volume V is large enough to accommodate the electrical energy reception device 2 in the retracted position.

In the embodiment illustrated, the compartment 3 comprises a fixed first wall 34, intended to be attached to the fuselage of the aircraft, and a second wall 35, mounted with the ability to move, possibly to pivot, between a closed position and a position referred to as the fully-open position. The compartment 3 also comprises a third wall 36 in the shape of a butterfly having two wings 37, 38, one on each side of an axle 39. The wing 37 is intended to be attached to the fuselage, whereas the wing 38 is mounted with the ability to pivot about the axle 39 between a closed position and a position referred to as the fully-open position.

The closed position of the wall 35 coincides with the closed position of the wing 38, and these closed positions define the closed position of the fairing 31.

The fully-open position of the wall 35 coincides with the fully-open position of the wing 38, and these fully-open positions define the fully-open position of the fairing 31.

The fixed wall 34 has a curved shape extending between an attachment edge 40 for attachment of the compartment 3 to the fuselage of the aircraft, and a junction edge 41 for connecting with the wall 35.

The mobile wall 35 has a curved shape, for example with a cross section in the shape of a circumflex accent or an arc of a circle, extending between an articulation edge 42 and a free edge 43. In the closed position, the edge 42 is contiguous with the edge 41 of the fixed wall 34. The free edge 43 describes a circular arc C-43, illustrated in dotted line in FIG. 4, between the closed position and the fully-open position. In other words, the fully-open position of the mobile wall 35 corresponds to the end-of-travel of the free edge 43 after it has travelled along the circular arc C-43, starting from the closed position. In the embodiment illustrated, the sector corresponding to the circular arc C-43 is an angle of 80°.

The wing 37 has a flat shape between an attachment edge 44 for attaching the butterfly wall 36 to the fuselage, and the axle 39. The wing 38 has a flat shape between the axle 39 and a free edge 45. In the closed position, the edge 45 is contiguous with the free edge 43 of the wall 35. The free edge 45 describes a circular arc C-45, illustrated in dotted line in FIG. 4, between the closed position and the fully-open position. In other words, the fully-open position of the mobile wall 36 corresponds to the end-of-travel of the free edge 45 after it has travelled along the circular arc C-45, starting from the closed position. In the embodiment illustrated, the sector corresponding to the circular arc C-45 is an angle of 90°.

Thus, when the wall 35 and the wing 38 are in the closed position, the fairing 31 is closed and the structural element 8 and the walls 34, 35 and 36 delimit the internal volume V. In this position, the electrical energy reception device 2 is enclosed in the volume V in the retracted position.

When the wall 35 and the wing 38 are at the end of their respective travel, in the fully-open position, the electrical energy reception device 2 may be deployed.

Advantageously, the parallel arms 10 and 11 are laid against an internal surface of the mobile wall 35, for example via studs 46.

The operation of the system 1 when fitted to the aircraft A is now described.

In the flight phase, the system 1 is in the rest position: the fairing 31 is closed and the compartment 3 houses the device 2 in the retracted position. In this position, the system 1 increases the drag only slightly and has little or no impact on the aerodynamic efficiency of the aircraft A.

In the taxiing phase, a control unit operates the system 1 to bring it into the working position. The hook pivots about the axle 22, thereby unlocking the system 1. The actuator 7 pushes the support 6 against the mobile wall 35, thereby opening the compartment 3. When the fairing 31 is in the fully-open position, the actuator 17 pushes the carriage 20 against the ground.

Once it has been fully deployed, the device 2 may receive electrical energy from the transmitter 5, either in a contactless manner, or by contact.

Conversely, when the aircraft is in the position for takeoff, the device 2 is retracted into the compartment 3, which closes again, so that the system 1 does not disrupt flight.

It should be noted that, although this has not been depicted in FIGS. 1 to 6, the system 1 according to the first embodiment also advantageously comprises a tensioner, such as an actuating cylinder 17 for example, in order to hold the carriage 20 on the ground. Thus, the actuating cylinder 17 ensures either a constant distance between the pad 26 and the ground (first variant), or continuous contact between the contacts 27 and the ground (second variant).

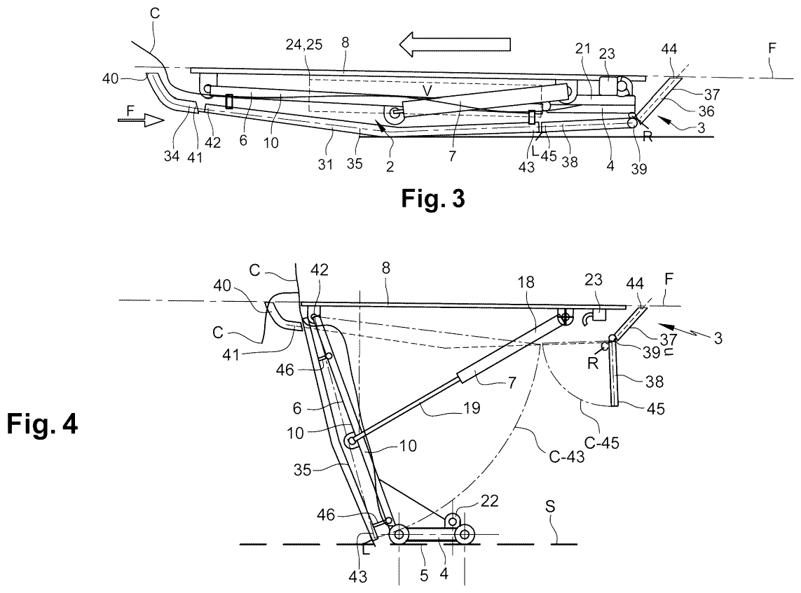

FIGS. 3 and 4 depict a lip L along the edge 43, and this lip enables the compartment 3 to be held correctly in the closed position and ensures that the system 1 is suitably aerodynamic in flight. These figures also depict a roller R against which the carriage 20 presses as the compartment closes, and which causes the wing 38 to close.

Thus, the system 1 is a quieter and more ecological way of moving the aircraft during taxiing while at the same time adding minimal additional weight and causing minimal disturbance to the aircraft in flight. In particular, by virtue of the system 1, the aircraft no longer consumes fuel during the taxiing phase and reduces its emissions of toxic gases such as NOx and COx.

In the embodiment illustrated, the system 1 takes the form of a module, that need merely be attached to the fuselage of an aircraft, thereby enabling an aircraft to be equipped therewith easily, and enabling the system to be manufactured while the aircraft is being assembled in order to save time. Nevertheless, the invention is not restricted to this embodiment, and covers another embodiment wherein the system 1 does not have the structural element 8 which, instead of forming part of the system, forms part of the fuselage. In that embodiment, the fuselage is equipped with hinges for the energy reception device 2 and mounting plates for attaching the fairing 31.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

Modifications and improvements to the implementations described above of the present invention may occur to a person skilled in the art. In particular, the embodiments and variants described can be combined provided that they are not incompatible. The above description is illustrative by means of examples rather than limiting. The scope of the present invention is therefore limited solely by the scope of the claims below.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An electrical energy reception system for an aircraft, comprising:
an electrical energy reception device, the electrical energy reception device comprising an electrical energy reception element, called a receiver, configured to receive electrical energy emitted by an electrical energy emitting element, called a transmitter, the electrical energy reception device mounted so to move between a retracted position and a deployed position; and,
a compartment for housing said electrical energy reception device in the retracted position.

2. The electrical energy reception system according to claim 1, wherein the electrical energy reception device comprises a holding structure for the receiver and at least one actuator for driving the holding structure between the retracted position and the deployed position.

3. The electrical energy reception system according to claim 1, wherein the compartment comprises a fairing equipped with at least one mobile wall configured to move between a closed position in which the compartment is closed and an open position in which the compartment is fully open, the electrical energy reception system being configured such that when the compartment is in the closed position, the electrical energy reception device is in the retracted position, housed inside the compartment, and when the compartment is in the open position, the electrical energy reception device is in the deployed position, the receiver being positioned outside of the compartment.

4. The electrical energy reception system according to claim 3, wherein the electrical energy reception device comprises a holding structure for the receiver and at least one actuator for driving the holding structure between the retracted position and the deployed position, and
wherein said at least one mobile wall is secured to the holding structure so that the at least one actuator drives said at least one mobile wall between the closed position and the open position.

5. The electrical energy reception system according to claim 1, further comprising:
an actuator for pivoting the receiver.

6. The electrical energy reception system according to claim 1, further comprising:
a carriage carrying the receiver.

7. The electrical energy reception system according to claim 1, further comprising:
a locking means locking the electrical energy reception device in the retracted position.

8. The electrical energy reception system according to claim 1, wherein the electrical energy reception device comprises a holding structure for the receiver and at least one actuator for driving the holding structure between the retracted position and the deployed position, and
further comprising:
a structural element configured to be attached to a fuselage of the aircraft and secured to the holding support and to the at least one actuator.

9. The electrical energy reception system according to claim 8, further comprising:
at least one arm extending between a first end secured to the structural element via a pivot connection and a second end secured to the receiver via a pivot connection.

10. The electrical energy reception system according to claim 1, wherein the receiver comprises an induction pad for collaborating with the transmitter in a contactless manner, or a contact for collaborating with the transmitter by contact, or both.

11. The electrical energy reception system according to claim 1, further comprising:
an electric motor configured to operate at least one wheel of a landing gear of the aircraft and configured to be electrically powered via the receiver.

12. An aircraft comprising:
the electrical energy reception system according to claim 1.

13. The aircraft according to claim 12, wherein the compartment is attached to a fuselage of the aircraft.

14. An electrical energy transfer system comprising:
the aircraft according to claim 12; and
an electrical energy transmitter configured to electrically power the receiver when the electrical energy reception system is in the deployed position.
